(19) United States
(12) Patent Application Publication
(10) Pub. No.: US 2026/0359673 A1
(43) Pub. Date: Nov. 12, 2026

(54) ENHANCING LARGE LANGUAGE MODEL REASONING ABILITIES OVER LONG CONTEXT

(71) Applicant: INTERNATIONAL BUSINESS MACHINES CORPORATION, ARMONK, NY (US)

(72) Inventors: Payel Das, YORKTOWN HEIGHTS, NY (US); Sihui Dai, New Providence, NJ (US); SUBHAJIT CHAUDHURY, White Plains, NY (US); Georgios Kollias, White Plains, NY (US); Ching-Yun Ko, Cambridge, MA (US); Aurelie Lozano, Scarsdale, NY (US)

(21) Appl. No.: 19/195,666

(22) Filed: Apr. 30, 2025

(51) Int. Cl. G06N 5/04; G06N 20/00

(52) U.S. Cl. CPC G06N 5/04; G06N 20/00

(57) ABSTRACT

A method for reasoning with a large language model (LLM) includes writing context encodings to an episodic memory and performing a search over the context encodings. The results from the search are fed to a decoder to execute a task. The context encodings are temporally encoded in the memory.

### BACKGROUND

The present disclosure generally relates to systems and methods for enhancing large language models (LLMs), and more particularly, to enhancing a multi-hop reasoning ability of LLMs over long context.

Transformer-based LLMs have recently shown impressive performance in many natural language processing (NLP) tasks, including machine translation, question answering, and reading comprehension, demonstrating the signature of general reasoning abilities. Despite these achievements, LLMs often fail to generate accurate information with respect to the context and are prone to hallucinations. Perhaps surprisingly, such hallucinations are found even on simple tasks that require some form of reasoning over the context. Oftentimes, irrespective of the specific type of reasoning involved, LLM hallucinations occur from failure to resolve a dependency chain over the input, rather than memorizing the exact training sequence. This issue of incorrectly modeling long-range dependency and reasoning has been reported for a variety of tasks including logical reasoning and algorithmic reasoning.

### SUMMARY

In one embodiment, a novel language model architecture is designed to naturally handle iterative processing over the context to learn long-range dependencies. This model is referred to herein as “MemReasoner”, which is a memory augmented language model enhanced with two basic operations: (i) explicit learning of temporal orders of facts/events present within the context, and (ii) a mechanism for iteratively reading from the context and updating the query accordingly. Embodiments further explore benefits of utilizing none-to-weak supporting fact supervision (along with final answer supervision) during model training.

In one embodiment, a computer implemented method and a computer program product can be configured for reasoning with an LLM, including writing context encodings to a memory and performing a search over the context encodings. Results from the search are fed to a decoder to execute a task. The context encodings are temporally encoded in the memory.

In another embodiment, a system includes a processor; a data bus coupled to the processor; a memory coupled to the data bus; and a computer-usable medium embodying a computer program code, the computer program code comprising instructions executable by the processor. The computer program code is configured to write context encodings to a memory and perform a search over the context encodings. Results from the search are fed to a decoder to execute a task. The context encodings are temporally encoded in the memory.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows performance of generative pre-trained transformer (GPT)-4 on different reasoning tasks (on the BABILong dataset) over context length;

FIG. 2 shows examples of single hop tasks and 2-hop tasks for an LLM;

FIG. 3 shows a diagram of a pipeline for reasoning with MemReasoner where q denotes the query, c₁, . . . , c_{E} denotes the context for answering the query. z_{q} denotes the encoding of the query while {z₁, . . . , z_{E}} denote encodings of each line of the context, and \tilde{z} to denote temporally encoded latents, consistent with an illustrative embodiment;

FIG. 4A shows an algorithm for the MemReasoner function, consistent with an illustrative embodiment;

FIG. 4B shows an algorithm for the temporal encoding function, consistent with an illustrative embodiment;

FIG. 4C shows an algorithm for the queryUpdate function, consistent with an illustrative embodiment;

FIG. 4D shows an algorithm for the InferenceTimeUpdate function, consistent with an illustrative embodiment;

FIG. 5 illustrates a loss function equation, consistent with an illustrative embodiment;

FIG. 6A shows performance of MemReasoner and baselines on varying lengths of BABILong data for a first task;

FIG. 6B shows performance of MemReasoner and baselines on varying lengths of BABILong data for a second task;

FIG. 6C shows performance of MemReasoner and baselines on varying lengths of BABILong-soft data for a first task;

FIG. 6D shows performance of MemReasoner and baselines on varying lengths of BABILong-soft data for a second task;

FIG. 7A shows results on a 1-hop variable tracking task;

FIG. 7B shows results on a 2-hop variable tracking task, with and without supporting fact (SF) supervision;

FIG. 8 shows data from Table 1, as described herein;

FIG. 9 shows data from Table 2, as described herein;

FIG. 10 shows data from Table 3, as described herein; and

FIG. 11 is a functional block diagram illustration of a computer hardware platform that can be used to implement the method for reasoning with an LLM, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide systems and methods that can provide a memory-augmented LLM architecture, referred to herein as “MemReasoner”, in which the memory learns the relative order of facts in context, and enables hopping over them, while the decoder selectively attends to the memory. MemReasoner is trained end-to-end, with optional supporting fact supervision of varying degrees. MemReasoner can be trained on two distinct synthetic multi-hop reasoning tasks. Experiments performed under a variety of challenging scenarios, including the presence of long distractor text or target answer changes in test set, show strong generalization of MemReasoner on both single- and two-hop tasks. This generalization of MemReasoner is achieved using none-to-weak supporting fact supervision (using none and 1% of supporting facts for one- and two-hop tasks, respectively). In contrast, baseline models overall struggle to generalize and benefit far less from using full supporting fact supervision. The results highlight the importance of explicit memory mechanisms, combined with additional weak supervision, for improving large language model's context processing ability toward reasoning tasks.

According to an aspect of the present disclosure, there is provided a computer-implemented method, a system and a computer program product for reasoning with an LLM, where the method includes computer-implemented method for reasoning with an LLM including writing context encodings to a memory and performing a search over the context encodings. The results from the search are fed to a decoder to execute a task. The context encodings are temporally encoded in the memory. Such a system can improve the functionality of the LLM by allowing accurate query responses, especially over long contexts.

In an embodiment, which can be combined with the preceding embodiment, the method further includes using ground truth supporting fact supervision for executing the task.

In an embodiment, which can be combined with one or more of the preceding embodiments, the context encodings are latent representations thereof.

In an embodiment, which can be combined with one or more of the preceding embodiments, the method further includes performing multiple hops over the latent representations of the context encodings to execute the task.

In an embodiment, which can be combined with one or more of the preceding embodiments, the method further includes performing a query update to reflect a most recent hop in the multiple hops over the latent representations.

In an embodiment, which can be combined with one or more of the preceding embodiments, the memory is episodic memory.

In an embodiment, which can be combined with one or more of the preceding embodiments, the method further includes performing multiple iterative reads from the memory to execute the task.

In an embodiment, which can be combined with one or more of the preceding embodiments, the method further includes training the LLM with supervision on both a sequence of intermediate and final reasoning steps based on a loss objective.

In an embodiment, which can be combined with one or more of the preceding embodiments, the loss objective includes a training loss tied to architectural changes to support multi-hop, temporal question-answer (QA) settings.

In an embodiment, which can be combined with one or more of the preceding embodiments, the method further includes generalizing on unseen test distributions during training, wherein reasoning supporting facts are scattered across long natural text contexts.

In an embodiment, which can be combined with one or more of the preceding embodiments, where an answer distribution or a number of hops in test samples differs from that in a training set.

Although the operational/functional descriptions described herein may be understandable by the human mind, they are not abstract ideas of the operations/functions divorced from computational implementation operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may train a LLM to execute temporal processing and iterative read over the context written to a latent memory module that is separate from the transformer decoder. A positional encoding scheme can learn the relative order of facts in memory to help with selective attention of the transformer decoder to the memory.

This may have the technical effect of enhancing the reasoning ability of the LLM, particularly over long contexts. Accordingly, the system and methods according to aspects of the present disclosure provide a substantial improvement to technology and computer functionality.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

Embodiments of the present disclosure provide a novel memory-augmented LLM architecture, namely MemReasoner, which is trained to execute temporal processing and iterative read over the context written to a latent memory module that is separate from the transformer decoder. For this purpose, a positional encoding scheme is proposed to learn the relative order of facts in memory, that helps with selective attention of the transformer decoder to the memory.

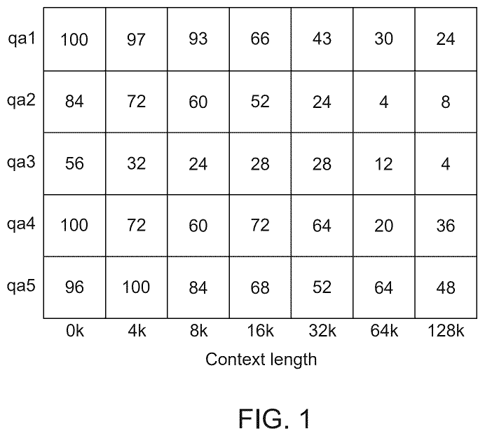

As shown in FIG. 1, when question-answer (QA) tasks are provided to an LLM, the successful results are shown on a scale of 0 to 100 percent successful. As can be seen, as the context length increases, the success rate for the QA task dramatically decreases.

The architecture, according to embodiments of the present disclosure, was evaluated, along with a number of language model baselines with and without a memory, on two synthetic multi-hop reasoning-in-a-haystack tasks (1) babi—that include 1-hop and 2-hop logical reasoning tasks and (2) variable tracking (VT)—that require tracking entities with 1- and 2-hop connections.

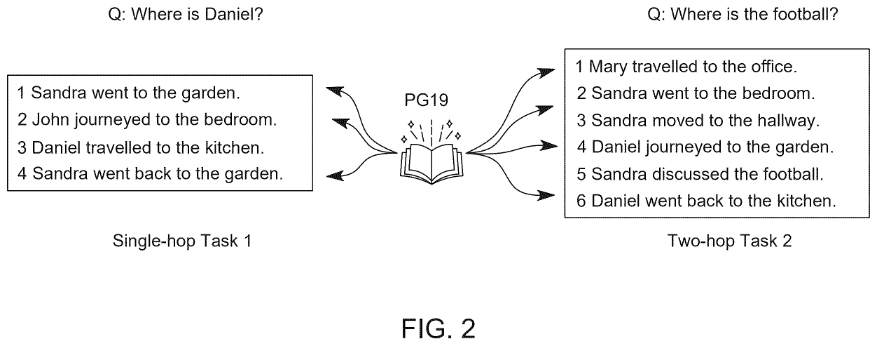

FIG. 2 illustrates an example of a one-hop task and a two-hop task. With a one-hop task, the answer to the query may be found directly in a single element of the context provided to the LLM. With a multiple-hop task, such as a two-hop task, multiple hops, such as two hops, multiple elements of the context are required to arrive at an answer to the query.

The task-finetuned models were subjected to a variety of challenging generalization scenarios. Results show that MemReasoner, when compared to existing recurrent baselines, including a memory-augmented recurrent transformer (RMT) model, and Mamba, a state-space model, generalize better in the single hop task setting, where target answer, context length with hard/soft distractors, task complexity, or a combination of thereof, differs from training to test distribution.

On tasks that require two hops, MemReasoner benefits from additional weak supervision on supporting facts. With usage of supporting facts only on 1% of training samples, the proposed model better generalizes to many different test scenarios, when compared to the baselines that utilize 100% of available supporting fact samples.

Multi-step Reasoning with MemReasoner

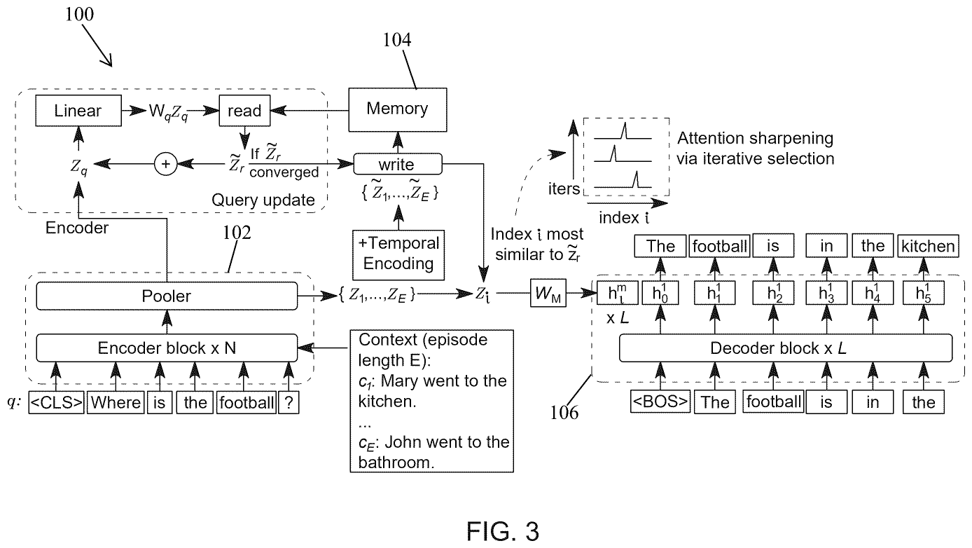

The components of MemReasoner architecture 100 include an LM encoder 102, an episodic memory module 104, and an LM decoder 106 (see FIG. 3). The role of the episodic memory module 104 is to enable write of the context encodings in the memory, to allow performing search over the context encodings and read from them, in order to feed the decoder 106 to execute the task. Given a reasoning task, for which the final answer is available, the MemReasoner architecture 100 is trained to recover the final answer, with or without using the ground truth supporting fact supervision.

An additional point worth mentioning is that MemReasoner is also trained to learn the relative order of the facts in the context and use that for memory write/read, which can be crucial for explicitly maintaining temporal ordering of context. A search in the latent memory space is performed during training, to correctly output the final answer (and optionally the supporting facts). This imposes a “selection” mechanism over the memory of the context and helps “sharpening” the decoder's attention over the fact that matters for correct output generation. It should be noted that the use of supporting fact supervision is optional. Training scenarios are considered that involve none-to-full supporting fact supervision with different loss objectives to study the benefits of various degrees of supervision. Details are provided below.

### Using the Larimar Framework as Backbone for MemReasoner

The backbone memory-augmented LLM is Larimar, although it should be understood that the approach described herein could in principle be used in conjunction with other LLMs augmented with an additional (episodic) memory module. Let X be the LM input space, [symbol] be the latent space, and [symbol] be the LM output space. Larimar features an encoder e that maps an input to an embedding z∈ [symbol] ⊆ [symbol] ^{D}, and a memory module [symbol] . The memory [symbol] is adaptable in the sense, that it allows “write” and “read” operations as episodes (aka, contexts C, where each context is comprised of E sentences) arrive, i.e., [symbol] =write (M, z), z_{read}=read (M, z), wherein [symbol] is the updated memory after an write, and, a decoder d that performs generations conditioned on the memory readout z_{read}.

Now, suppose one is given an input context C={c₁, . . . , c_{E}} with E denoting the length of the context, and the target task is to answer a question q conditioned on the given context C. To approach the task within the Larimar framework, the input, both context C and query q, are encoded to their latents (z₁, . . . , z_{E} and z_{q}) via the encoder e. Next, let M₀ be the initial memory, write the context to the memory via a write operation. To do so, the memory is viewed as a global latent variable in a generative model. In this framework, the goal is to learn a memory dependent data prior and learnable addresses, where the memory update and read/write are considered as Bayesian inference, i.e., the posterior parameters are updated as new data arrives. The Bayesian updates for encoding new memories and for decoding data can be reformulated from memories into an equivalent minimization problem, which essentially amounts to solving a linear system of equations and can be efficiently done via computing matrix pseudo inverses indicated by † hereafter.

Specifically, memory is updated via the write operation such that,

$$\hat{M} = {( {Z}_{ξ} {M}_{0}^{†} )}^{†} {Z}_{ξ} , \\ where \\ {Z}_{ξ} = [ {z}_{1} + {ξ}_{1} , {z}_{2} + {ξ}_{2} , … , {z}_{E} + {ξ}_{E} ] \\ and \\ {ξ}_{i} ∼ 𝒩 ( 0 , {σ}_{ξ}^{2} I ) .$$

Then, the read operation translates the query embedding from the lens of the encoded memory to a query readout zᵣ via

$${z}_{r} = ( {z}_{q} {\hat{M}}^{†} + η ) \hat{M} , \\ where \\ η ∼ 𝒩 ( 0 , {σ}_{η}^{2} I ) .$$

Lastly, the decoder d decodes the query q conditioned on the readout by using a learnable broadcasting matrix of parameters W_{M} that casts zᵣ to each decoder layer and obtains

$${h}_{k}^{m}$$

that serves as the past key values for k=1, . . . , L, where L is the number of layers in the decoder.

The memory-augmented LLM architecture of Larimar is used and the above operations as the backbone for MemReasoner, due to its memory and space-efficient read/write abilities and demonstrated generalizability at test-time.

However, as such, Larimar's mechanisms are insufficient to handle complex tasks, such as making multi-hop connections over the context. Additional features are provided in MemReasoner to handle such tasks: (i) explicit learning of temporal orders of facts/events present within the context, and (ii) mechanism for iteratively reading from the context and updating the query accordingly.

Memory with Temporal Order

In Larimar, the latent encoding of facts {z₁, . . . , z_{E}} within a context episode C are written in the memory M in an order invariant manner. However, many multi-step reasoning tasks require some notion of temporal context. For example, when answering “where is John?” in the context of “[ . . . ] John is in the bathroom. [ . . . ] John goes to the garden.” (‘[ . . . ]’ denotes irrelevant facts), there should be a mechanism in place to guarantee that the memory encodes the correct temporal order of the facts, and the readout should reflect “John goes to the garden.” as the supporting fact instead of “John is in the bathroom.”.

To introduce some temporal notion within the context (i.e., facts that appeared later in context are more recent), in MemReasoner, a temporal encoding module P is introduced that transforms un-ordered fact latents {z₁, . . . , z_{E}} within a context episode to their ordered counterparts {\tilde{z}₁, . . . , \tilde{z}_{E}}. A learnable bidirectional gated recurrent unit (GRU) can be leveraged for temporal encoding, i.e., {\tilde{z}₁, . . . , \tilde{z}_{E}}←GRU ({z₁, . . . , z_{E}}). This temporal encoding module P, however, is generic and allows any structure featuring sequentiality within contexts. These ordered context embeddings {\tilde{z}₁, . . . , \tilde{z}_{E}} are then written to memory via Larimar's write operation.

It is worth mentioning that conventional memory-augmented neural nets, which use a recurrent neural net together with an external memory, have investigated ideas like temporal feature learning and iterative hops over context. However, embodiments of the present disclosure provide the first study to enable those operations around a latent memory coupled to a transformer-based LLM during training and to test the resulting model's generalizability on long-range dependency learning.

### Iterative Read And Query Update

A typical multi-step reasoning task often inherently requires “hops” between facts until the final solution is found. Additionally, the query embedding can be updated accordingly to reflect the most recent hop.

In order to perform hopping between facts, recall the three components interacting with the memory module [symbol] , the fact embeddings ({z₁, . . . , z_{E}}) within a context episode, the query embedding z_{q}, and the memory readout zᵣ. Assuming that [symbol] stores facts that have been ordered temporally {\tilde{z}₁, . . . , \tilde{z}_{E}}.

To enable iterative read, z_{q} can be passed through a linear layer to obtain [symbol] =W_{q}z_{q} before the read operation from the memory, where W_{q}∈ [symbol] ^{D×D} is a learnable parameter that absorbs the scale changes introduced by the position encoding in the memory. Specifically, different from that described above, here zᵣ=( [symbol] \hat{M}^{†}+η) \hat{M}.

To update the query, the query latent is first updated, and let z_{q}←z_{q}+α·zᵣ, where α∈ [symbol] is a hyperparameter to balance the load from the previous readout. The updated query is then fed into the memory module for another read operation to obtain a new \tilde{z}ᵣ. The query update procedure is repeated until the readout converges (i.e.,

$${‖ {\tilde{z}}_{r}^{t} - {\tilde{z}}_{r}^{t + 1} ‖}_{2} < τ , \\ where \\ {\tilde{z}}_{r}^{t}$$

denotes the readout at time t and τ is a hyperparameter) or until it reaches a fixed number of maximum iterations.

### Inference-Time Update (IU)

To generalize on long-context tasks with a memory-augmented LLM, a potential hurdle can come from the two fundamental operations of the memory, write and read, as described above. In both operations, numerical solves of the linear systems involve computing matrix pseudo inverses, which can be unstable when the matrix has many more columns than rows or the other way around. Secondly, encoding the temporal order in very long facts with a GRU can further incur vanishing or exploding gradient.

To cope with these, an optional inference-time update (IU) step can be introduced, which includes dynamically filtering irrelevant contexts before re-encoding the temporal order and the memory operations. Specifically, with the first pass of memory write and query read, a subset of contexts can be identified that are most relevant to the query by their proximity in the ordered latent space (∥\tilde{z}ᵣ−\tilde{z}ⱼ∥₂).

Then, the temporal order on this remaining context (much shorter) can be re-encoded to get their ordered counterparts for the subsequent memory write and query read. This optional update step enables the model to focus on the most relevant information and avoids numerical instabilities. All MemReasoner performance values described herein were obtained using IU, unless otherwise stated.

### Full Workflow

Now that all of the components of MemReasoner have been described, the full pipeline can be elaborated in the following and a visualization is provided in FIG. 3.

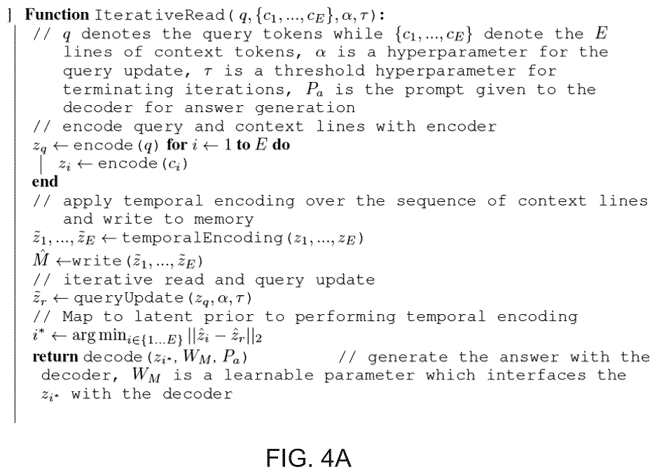

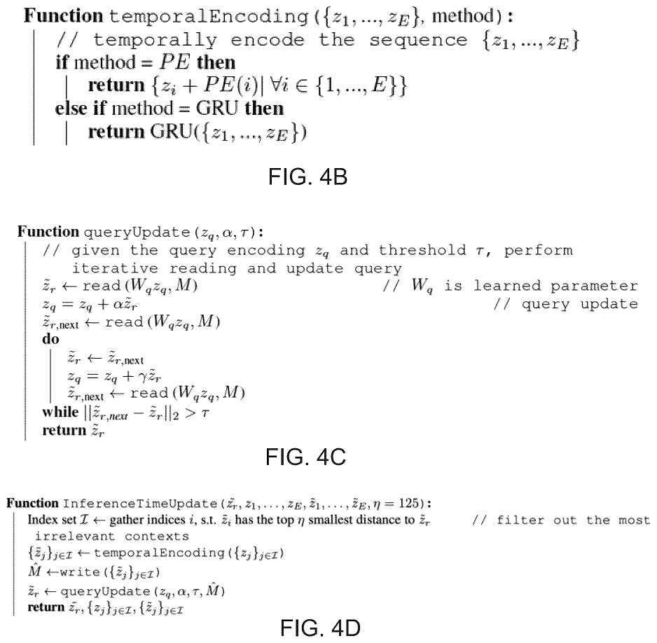

Consider an input context C={c₁, . . . , c_{E}}, a question q, an encoder e, a temporal encoding module [symbol] , an initial memory module [symbol] , and a decoder d. The context C and query q are first encoded to their latents, z₁, . . . , z_{E} and z_{q} via encoder e. Then, z₁, . . . , z_{E} are transformed to \tilde{z}₁, . . . \tilde{z}_{E} as described above. Next, the ordered context \tilde{z}₁, . . . \tilde{z}_{E} are written to the memory and \hat{M} is obtained. Subsequently, the process reads using the query latent from the memory \hat{M} and performs query and read updates as discussed above. After obtaining a \tilde{z}ᵣ as a final readout which does not undergo update anymore, \tilde{z}ᵣ is mapped to the corresponding unordered encoding in M. This is because only the additional position information is to be used when locating the most relevant contexts, but not during the decoding—if being fed to the decoder, the decoder may overfit to the ordering information in the latents. This can be done by first finding the index of the most similar ordered latent encoding i=arg min_{j∈{1, . . . , E}} ∥\tilde{z}ᵣ−\tilde{z}ⱼ∥₂ and then obtaining the corresponding encoding zᵢ from the unordered encodings (prior to undergoing temporal encoding in FIG. 3) {z₁, . . . , z_{E}}. Lastly, the decoder d decodes the prompt Pₐ given for answer generation conditioned on zᵢ. The full pseudocode is provided in FIGS. 4A through 4D.

### Training Objectives

Let Dₚᵣₑₜᵣₐᵢₙ denote the pretraining data distribution, while D_{finetune} denotes the data distribution corresponding to the reasoning task. Each sample from D_{finetune} is of the form (q, C, a) where q is the query, C={c₁, . . . , c_{E}} are the facts in the context, and a is the answer. Depending on the availability of supporting fact information in each sample, let

$${D}_{finetune}^{*}$$

be the subset of samples with ground truth supporting fact, i.e., each sample from

$${D}_{finetune}^{*}$$

is of the form (q, C, a, S), where S is a set of indices corresponding to the supporting facts (Sᵢ is used to denote the i^{th} supporting fact index in S). Meanwhile, the pretraining distribution corresponds to a generic corpus, e.g., Wikipedia.

Remember, e denotes the encoder, d denotes the decoder, t denotes temporal encoding,

$${\tilde{z}}_{r}^{i}$$

denotes the i^{th} temporally encoded readout from iterative reading with

$${\tilde{z}}_{r}^{0} = q , {z}_{r}^{i}$$

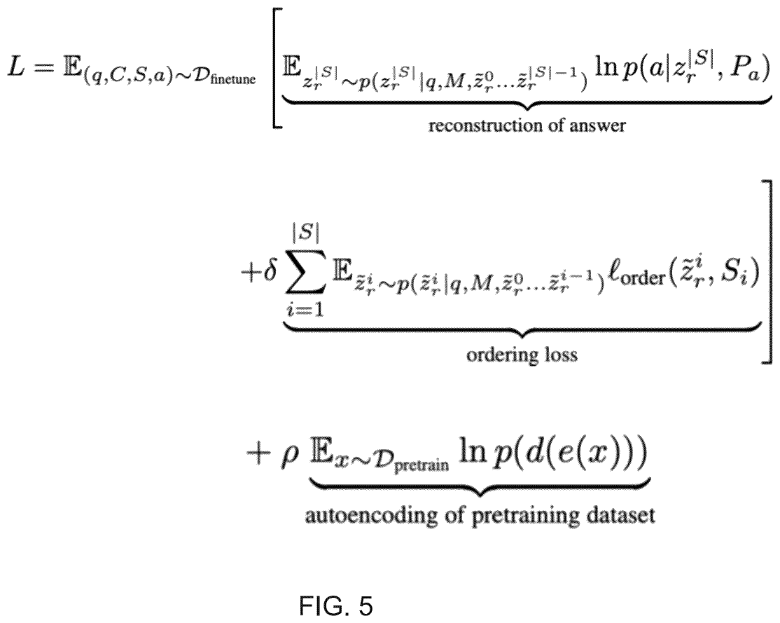

represent the unordered encoding corresponding to the i^{th} ordered readout, and Pₐ denotes the prompts for generating the answer. To train the model, the loss function illustrated in FIG. 5 can be utilized, where δ and ρ are hyperparameters controlling regularization strength and l_{order} is given by

v(zᵣ)=softmax([−|t(e(c₁)))−zᵣ∥₂, . . . −∥t(e(c_{E})−zᵣ∥₂]^{τ}) [symbol] _{order}(zᵣ,s)=−ln v(zᵣ)ₛ

In the overall loss L, the third term corresponds to the autoencoding loss on the pretraining dataset. The first term is the reconstruction loss of the answer with respect to the corresponding prompt for obtaining the answer Pₐ and final readout. Depending on the degree of supporting fact supervision, an optional second loss can be added, encouraging the index of the most similar entry (by l2 distance) to the ordered readout at each iteration to match the index of the supporting fact through computing the cross entropy. It should be noted that

$${D}_{finetune}^{*}$$

can be a smaller, as little as 1% of the training set size, subset of D_{finetune}, covering the realistic scenario when supporting fact supervision is scarce.

### Experimental Details and Results

### Task Datasets and Data Pre-Processing

Two sets of tasks were utilized, both of which involve fact chaining by drawing multi-hop connections over the context. Namely, the experimental resorts to tasks 1 and 2 from the synthetic bAbi benchmark, and the Variable Tracking (VT) task from the RULER benchmark.

bAbi Tasks. The bAbi datasets were prepared by synthesizing relations among characters and objects across various locations, each represented as a fact, such as “Mary traveled to the garden”. Task 1 requires performing a single hop to find the answer, whereas task 2 requires gathering two supporting facts in the right order (see FIG. 2 for examples of such tasks). For preprocessing bAbi data, each training sample comprised of multiple facts was treated as a single context episode, and individual sentence within that context as an instance within that episode. Each fact within an episode contains up to 64 tokens. In the experiments, training models were considered with bAbi task 1 and task 2 data. To evaluate the generalization of these models, harder variants of bAbi were considered, including BABILong and BABILong-soft.

BABILong. BABILong extends these single and multi-hop tasks to a long context setting where the difficulty of the task is further varied by changing the length of the irrelevant text added to the initial bAbi samples. The BABILong leaderboard shows tasks 1 and 2, while simple, are challenging enough for off-the-shelf LLMs to solve in the presence of hard (irrelevant) distractor text. For BABILong (used during inference), if sentences are longer than 64 tokens, the sentences were split at multiples of 64 tokens.

BABILong-soft. A variant of BABILong was created that contains soft distractors (in-distribution padding) instead of hard ones in the original dataset, which is referred to as BABILong-soft. Using this padding, the context length is increased up to 4 k tokens.

Location change. The robustness of models was also evaluated to modified bAbi test samples that have locations that are unseen during training. Specifically, locations mentioned in bAbi samples were mapped to a different location (i.e., office→library).

Variable Tracking (VT) tasks. Variable tracking, introduced by RULER benchmark, emulates a minimal coreference chain resolution task, which requires tracking relevant co-occurrence patterns and inferring skipped connections to bridge linked entities over long context. Specifically, the model is given context with lines with information about variable value assignment such as “VAR AAAAA=16438” or “VAR BBBBB=AAAAA”, and the model is prompted to obtain all variables with a specific value. Variable names in the present disclosure have the format of 5 repeating letters randomly sampled from the alphabet. The task complexity is further increased by adding more chains.

Chains of length 2, 4, 6, 8, and 10 were trained upon and evaluated and the average accuracy over all chain lengths was returned for the 1-hop and 2-hop VT tasks. In order to pad the context for lengths 1 k, 4 k, and 16 k during the test, the approach was taken from RULER of padding with the following sentences as hard distractors “The grass is green. The sky is blue. The sun is yellow. Here we go. There and back again. \n” until the context reaches the desired length. This noise is not present during training and the 0 k data follow the same distribution as the training data.

### Baseline Models

RMT and Mamba models that are finetuned on individual tasks were benchmarked and tested upon corresponding bAbi/BABILong and VT test samples. Specifically, off-the-shelf RMT and Mamba models were finetuned using the next token prediction loss on final answer reconstruction and optionally on supporting fact (SF) reconstruction (100% SF refers to all supporting facts used in training) on each task separately. This study is believed to be the first one to explore reasoning generalization of RMT and Mamba that use SF supervision. An RMT-0.14B model, finetuned on shorter BABILong samples, was evaluated on newly proposed BABILong-soft set. If not explicitly mentioned, the size of the RMT model is 0.77B and the same for Mamba is 1.4B. Task accuracy was reported as the performance metric, so the higher, the better.

### Results

Results on evaluating the generalization capabilities of MemReasoner and baseline models are presented. Across evaluation datasets, the results demonstrate that the design of MemReasoner allows it to take advantage of none-to-little supporting fact information, which largely improves its generalization capabilities. In comparison, other baselines generally struggle to generalize and do not benefit much from supporting fact information.

### Generalization on Long-Context Reasoning-In-a-Haystack Benchmarks

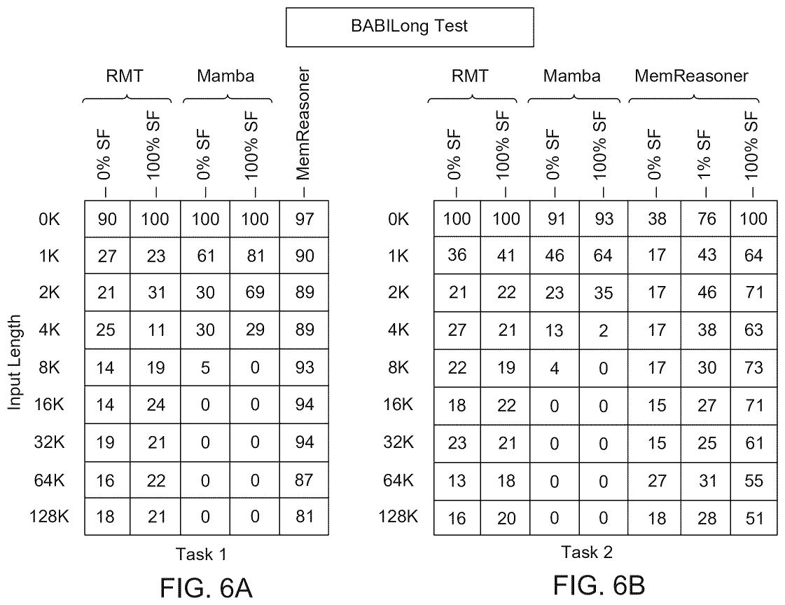

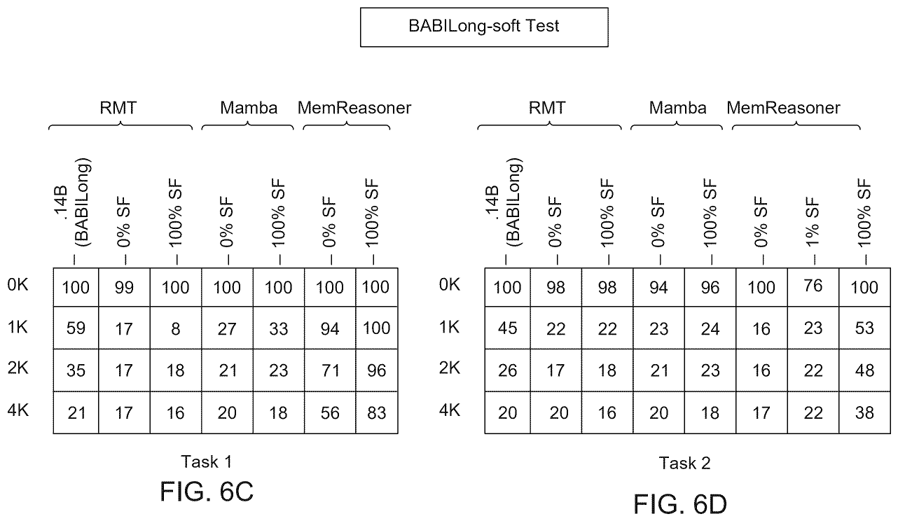

bAbi Tasks-BABILong Test. FIGS. 6A and 6B report the accuracy of MemReasoner, together with baseline models, on task 1 and task 2 test samples of varying length from BABILong, respectively. If supporting fact (SF) supervision is used during fine-tuning, it is mentioned explicitly as +x % SF, where x denotes amount of training samples that have corresponding supporting facts. If a model without SF supervision provides high accuracy, the results are not shown with +SF. RMT and Mamba, when finetuned on bAbi, achieve near-perfect accuracy on both tasks on original bAbi test samples. In contrast, MemReasoner trained with supervision on final answer only, while performing comparably on task 1, it falls short on task 2. This low test accuracy of MemReasoner is due to making frequent errors at the second hop on the challenging 2-hop task. It is noteworthy that even a powerful baseline like GPT-3 (175 B parameters) with few-shot and chain-of-thought prompting that performs well on task 1, does much worse on task 2 that requires learning temporal dependence and performing multiple hops across facts to generate the final answer of object location. Thus, supporting fact supervision is added (using ordering loss in eqn. 1) on 1% of the training samples. On 0 k test samples, MemReasoner+1% SF shows an accuracy improvement from 38% to 76%, while for MemReasoner+100% SF the accuracy becomes near perfect. This result suggests that MemReasoner benefits from a small amount of supporting fact supervision on a two-hop task.

bAbi-finetuned RMT and Mamba models show a significant accuracy drop on BABILong samples beyond 0 k input length, though both show near-perfect accuracy at 0 k. Interestingly, additional supervision on 100% supporting facts during RMT or Mamba training (in the form of supporting fact reconstruction loss) did provide none-to-little performance boost. In contrast, MemReasoner trained on bAbi generalizes well on BABILong for task 1, providing an average accuracy of 91.6% and 89% on ≤8 k and ≥16 k BABILong samples, respectively. On task 2, MemReasoner also shows a performance drop from 0 k to 1 k. MemReasoner+1% SF shows more robust performance on BABILong, as accuracy drops from 76% to only 43%, as input length increases from 0 k to 1 k. MemReasoner+100% SF variant maintains 50-70% accuracy for longer inputs up to 128 k.

bAbi Tasks—BABILong-soft Test. This long-context setting is more challenging. Therefore, in addition to the bAbi-finetuned models, the top-performing models from BABILong leaderboard were also included, i.e., an RMT-0.14B model finetuned on BABILong samples of up to 16 k tokens, for comparison. Results are shown in FIGS. 6C and 6D for tasks 1 and 2. On BABILong-soft task 1, all models lose accuracy compared to BABILong task 1. However, for MemReasoner, the performance drop is lowest throughout these context lengths. For task 2, all models exhibit even more striking performance loss as input length increases, while MemReasoner with additional supporting fact supervision shows more robust performance in the 1-4 k range.

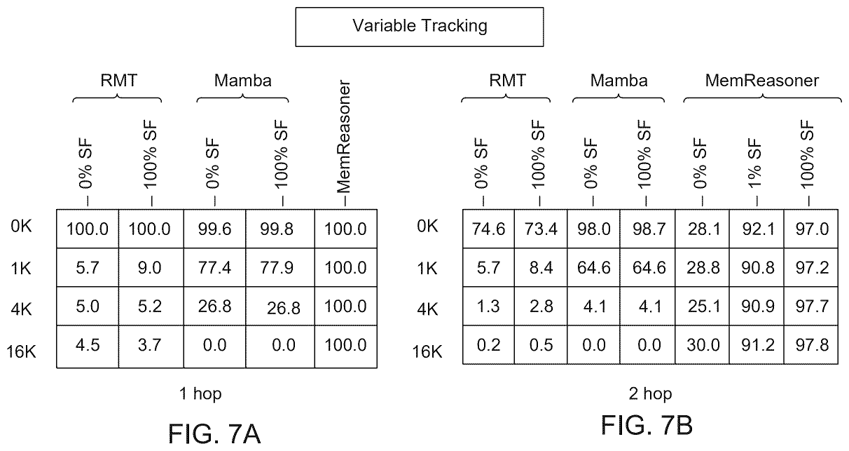

Variable Tracking-Ruler Test. FIGS. 7A and 7B reports results on 1- and 2-hop variable tracking tasks. Remember that the longer test samples (1-16 k length) from the RULER benchmark do include additional noisy distractors in the input. In the single-hop VT experiments, MemReasoner maintains perfect accuracy over the entire context length range, whereas RMT shows a sharp drop from 100% at 0 k to 5.7% at 1 k. Even adding supervision on all supporting facts does not help RMT's performance. Mamba performs better than RMT at 1 k, but also shows a stark accuracy lowering at 4 k, which cannot be fixed with supporting fact supervision.

For the 2-hop VT task, it was observed that it is difficult to train RMT with 2 segments. RMT can easily learn a shortcut and have high accuracy on the training set, but does not generalize well to the test set at 0 k length (74.6% accuracy). At this length, it was observed that RMT struggles with performance on longer chain lengths, achieving only 61.5% accuracy on 8 chains and 3% accuracy on 10 chains despite these chain lengths being present during training. Performance degrades further at longer context length. Again, access to supporting facts appears ineffective in fixing the underlying issue. Mamba without and with supporting fact supervision shows consistently better performance than RMT. MemReasoner in the absence of supervision on intermediate steps does poorly at 0 k (28.1% accuracy), while maintaining it for longer inputs. With 1% SF supervision, MemReasoner shows above 90% accuracy for the entire 0-16 k length range.

Generalization to Unseen Target Answers and from 2-Hop→1-Hop

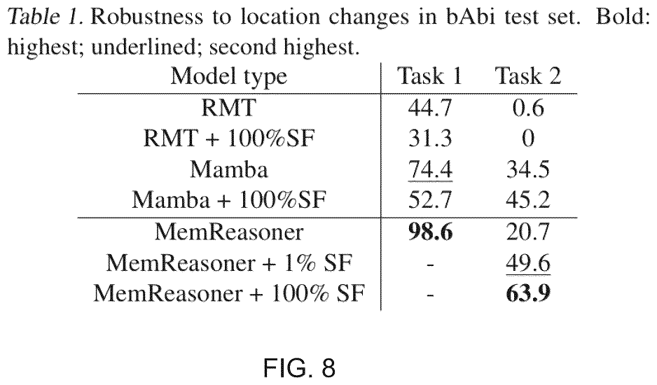

A new, more stringent testbed was created where the construct of the tasks remains the same, but the answer changes from training to test set. As shown in Table 1, provided herein as FIG. 8, when no SF supervision is used, on task 1 the accuracy order is RMT<Mamba<MemReasoner, while on task 2 the order is RMT<MemReasoner<Mamba. Given that, in this setting the length of the test sequence is similar to that of the training one, Mamba handles it better for task 2, with an accuracy of 34.5%, though MemReasoner with 1% SF supervision shows 63.9% accuracy compared to 45.2% for Mamba with 100% SF.

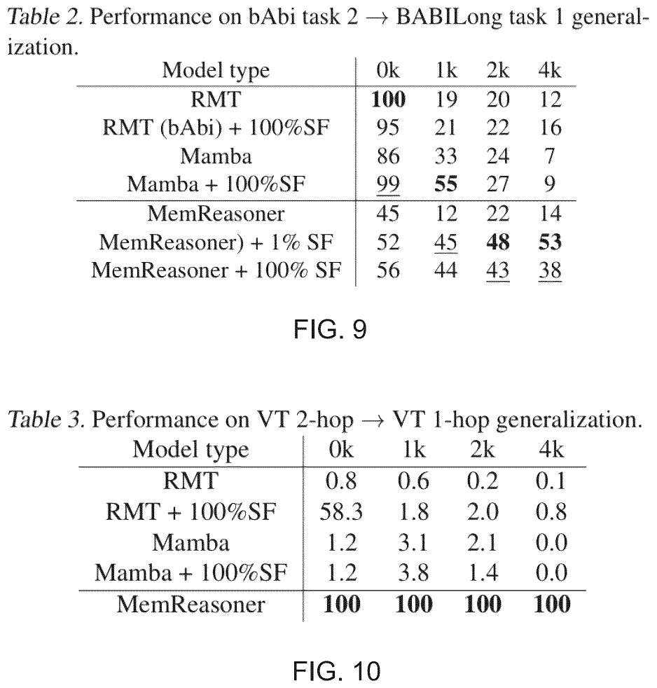

Finally, it was also checked if the models trained on 2-hop bAbi/VT can solve the simpler 1-hop version, but on the corresponding long context samples. The results are shown in Tables 2 and 3, provided herein as FIGS. 9 and 10, respectively. From the table, it can be seen that MemReasoner can generalize in this setting with no access to supporting facts for VT and with access to 1% of supporting facts for bAbi. Baseline models show minimal generalization at longer input length for the single-hop task and supporting fact supervision does not help much.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

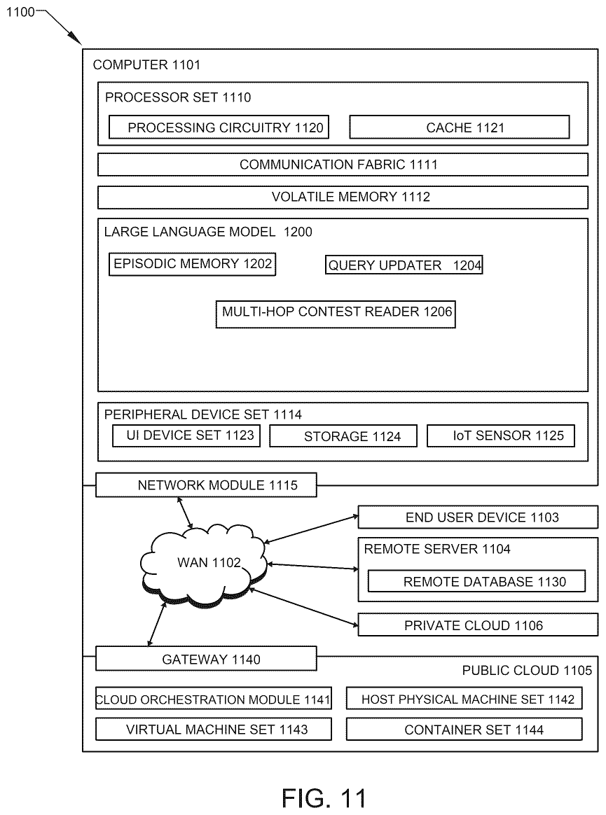

Referring to FIG. 11, computing environment 1100 includes an example of an environment for the execution of at least some of the computer code involved in performing the inventive methods, including an LLM block 1200, which can include an episodic memory block 1202, a query updater block 1204, and multi-hop context reader block 1206. In addition to block 1200, computing environment 1100 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI) device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 11. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction path that allows the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, volatile memory 1112 is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface-type operating systems that employ a kernel. The code included in block 600 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN 1102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for reasoning with a large language model (LLM), comprising:
writing context encodings to a memory;
performing a search over the context encodings; and
feeding a decoder results from the search to execute a task, wherein:
the context encodings are temporally encoded in the memory.

2. The computer-implemented method of claim 1, further comprising using varying amount of ground truth supporting fact supervision for executing the task.

3. The computer-implemented method of claim 1, wherein the context encodings are latent representations thereof.

4. The computer-implemented method of claim 3, further comprising performing multiple hops over the latent representations of the context encodings to execute the task.

5. The computer-implemented method of claim 4, further comprising performing a query update to reflect a most recent hop in the multiple hops over the latent representations.

6. The computer-implemented method of claim 1, wherein the memory is episodic memory.

7. The computer-implemented method of claim 1, further comprising performing multiple iterative reads from the memory and updating the memory to execute the task.

8. The computer-implemented method of claim 1, further comprising training the LLM with supervision on both a sequence of intermediate and final reasoning steps based on a loss objective.

9. The computer-implemented method of claim 8, wherein the loss objective includes a training loss tied to architectural changes to support multi-hop, temporal question-answer (QA) settings.

10. The computer-implemented method of claim 1, further comprising generalizing on unseen test distributions during training, wherein reasoning supporting facts are scattered across long natural text contexts.

11. The computer-implemented method of claim 1, wherein an answer distribution or a number of hops in test samples differs from that in a training set.

12. A system comprising:
a processor;
a data bus coupled to the processor;
a memory coupled to the data bus; and
a computer-usable medium embodying a computer program code, the computer program code comprising instructions executable by the processor and configured to:
write context encodings to an episodic memory;
perform a search over the context encodings; and
feed a decoder results from the search to execute a task, wherein:
the context encodings are temporally encoded in the episodic memory; and
the context encodings are latent representations thereof.

13. The system of claim 12, wherein the computer program code is further configured to perform multiple hops over the latent representations of the context encodings to execute the task.

14. The system of claim 13, wherein the computer program code is further configured to perform a query update to reflect a most recent hop in the multiple hops over the latent representations.

15. The system of claim 12, wherein the computer program code is further configured to perform multiple iterative reads from the memory to execute the task.

16. The system of claim 12, wherein the computer program code is further configured to train a large language model (LLM) with supervision on both a sequence of intermediate and final reasoning steps based on a loss objective.

17. The system of claim 16, wherein the loss objective includes a training loss tied to architectural changes to support multi-hop, temporal question-answer (QA) settings.

18. A computer program product for reasoning with a large language model, the computer program product comprising a computer readable storage medium having program instructions embodied therewith, the program instructions executable by a computer to cause the computer to:
write context encodings to an episodic memory;
perform a search over the context encodings; and
feed a decoder results from the search to execute a task, wherein:
the context encodings are temporally encoded in the episodic memory; and
the context encodings are latent representations thereof.

19. The computer program product of claim 18, wherein the program instructions are further configured to perform multiple hops over the latent representations of the context encodings to execute the task.

20. The computer program product of claim 19, wherein the program instructions are further configured to:
perform a query update to reflect a most recent hop in the multiple hops over the latent representations; and
perform multiple iterative reads from the memory and update the memory to execute the task.
